(19) United States
(12) Patent Application Publication
(10) Pub. No.: US 2004/0237834 A1
(43) Pub. Date: Dec. 2, 2004

(54) Anti-corrosion additive for compositions in contact with iron-based substrates

(76) Inventors: Eugene B. Humphrey, Hamden, CT (US); Michael S. Rhodes, Bronx, NY (US); James Humphrey, Cheshire, CT (US); Philip Rhodes, Teaneck, NJ (US); Leonid Izrailev, Brooklyn, NY (US)

Correspondence Address: CLIFFORD G. FRAYNE, Suite 7A, 136 Drum Point Road, Brick, NJ, 08723, US

(21) Appl. No.: 10/447,975

(22) Filed: May 29, 2003

(51) Int. Cl. C04B 9/02

(52) U.S. Cl. 106/14.13; 106/810; 252/389.62

(57) ABSTRACT

There is described a dialkali based salt solution of dioic acid as an anti-corrosive additive alone or in admixture in an effective amount with another composition such as concrete.

### BACKGROUND OF THE INVENTION

1. Field of the Invention

The present invention relates to an anti-corrosive additive composition, and more particularly to an anti-corrosive additive for concrete in reinforced concrete structures.

2. Description of the Prior Art

For structures made of reinforced concrete, the concrete has at least two functions, i.e. to absorb compressive strains and to protect reinforcing steel bars or re-bars against corrosion. The re-bars function to absorb shear and tensile stress.

The cost of corrosion is annually estimated to be in the billions with concomitant catastrophic collapses of structures and losses in lives. The protective effect of hardened concrete on re-bars depends, inter alia, on climatic and environmental conditions as a function of amount of cement, grain of concrete aggregate, water/cement factor and concrete compression.

In U.S. Pat. No. 4,869,752 to Jaklin, there is described the use of modified inorganic silicates, e.g. modified alkali silicates as a concrete additive to prevent corrosion of steel structures or steel re-bars.

In U.S. Pat. No. 6,277,450 to Katoot, there is described the use of a coating process to coat the surface of the metals which is modified to an active moiety of metal hydroxide receptive to a fully cross-lined polymer of various thickness.

Thus, the problem of corrosion as it relates to the use of reinforced concrete has been addressed, however, the problem still exists, and there is a need for an anti-corrosion additive providing for more effective corrosion protection for longer periods of time obviating costly precoating of surfaces of metals used in the building and construction industry.

### OBJECTS OF THE INVENTION

An object of the present invention is to provide for a novel anti-corrosive additive.

Another object of the present invention is to provide for a novel anti-corrosive additive which can be mixed with concrete prior to pouring and which protects the concrete by reducing water permeability and the concrete re-bar from corrosion.

A further object of the present invention is to provide for a novel anti-corrosive additive which can be admixed with other mediums prior to its application to prevent corrosion and decrease permeability.

A still further object of the present invention is to provide for a novel anti-corrosive agent that can be applied to the surface of existing concrete and that will migrate through the concrete to prevent corrosion on re-bar surfaces while reducing moisture permeability of the concrete.

### SUMMARY OF THE INVENTION

These and other objects of the present invention are achieved by use of an alkali based salt solution of dioic acid as an anti-corrosive additive, alone, or in an admixture in an effective amount with another composition as more fully hereinafter described.

### DETAILED DESCRIPTION OF THE INVENTION

The anti-corrosive additive of the present invention is the composition represented by the following formula:

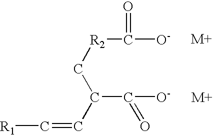

wherein M+ is selected from the group consisting of Na+ and K+; R₁ is a C₁ to C₂₄ branch linear aliphatic hydrocarbon and R₂ is a C₀-C₁₀ branch or linear aliphatic hydrocarbon and is prepared in accordance with the following reactions:

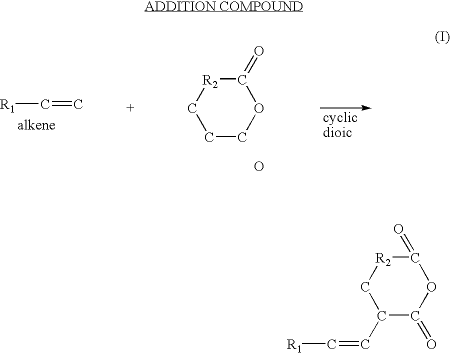

wherein the resulting addition compound is reactive with alkaline hydroxide as follows:

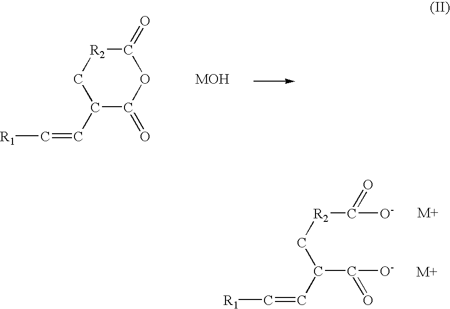

to form a disodium based salt solution of dioic acid serving as an anti-corrosive additive alone or in an effective amount admixed with a composition to be placed in contact with exposed iron or steel for subsequent application to the exposed iron or steel.

Reaction (I) is effected at elevated temperatures and pressures for a time sufficient to form the alkene dioic acid composition. The resulting material after removal of unreactive materials is introduced into a batch still or film evaporator to collect a distillate of alkene dioic acid composition. The alkene dioic acid composition is then introduced into a stainless steel reactor including a reflux condenser with an aqueous solution of sodium hydroxide being slowly introduced for a time and at a temperature sufficient to effect conversion thereof to the disodium salt solution.

The anti-corrosive additive of the present invention when used in a concrete application as an anti-corrosive additive to protect the reinforcing bar, is admixed with the concrete in a ratio of from 3 to about 5 pounds per cubic yard of concrete prior to the pouring of the concrete admixture.

The following examples are illustrative of the processing of the alkene and cyclic diene.

### EXAMPLE 1

To a stainless steel reaction vessel there is added 300 grams of 2,5-furanedione and 750 grams of tetramethylethylene together with one (1) gram of BHT antioxidant. The reaction mix is vigorously agitated at 250° C. under a N₂ blanket for 4 hours. After removal of unreacted material at reduced pressure, the resulting product is processed in a thin film evaporator at 235° C. and 5 mm of Hg collecting about 730 grams of product light fraction wherein the bottom fraction is waste.

The produced light fraction is introduced into a stainless steel reaction vessel including a reflux condenser and heated to 100° C. for 2 hours whereupon 80 grams of sodium hydroxide solution is slowly added and agitated until there is formed a clear yellow solution of a butane dioic acid dodecenyl disodium salt.

### EXAMPLE 2

Following the protocol of Example 1, there is reacted X grams of maleic anhydride and Y grams of propylene tetramer at 230° C. at 40 psi for 4 hours. After removal of unreactive materials a distillate is formed and after preliminary heating and agitation, there is slowly added sodium hydroxide in the amount of 0.27 grams to form a salt solution of a butane dioic acid dodecnyl disodium salt.

During the preparation of the anti-corrosive additive of the present invention, anti-foaming agents such as 2-methyloxymethylethoxy propane may be used in amounts of from 0.02 to 0.010% by weight. Additional stabilizing agents such as benzoic acid, maleic acid and the like may also be employed.

While the present invention has been described with respect to the exemplary embodiments thereof, it will be recognized by those of ordinary skill in the art that many modifications or changes can be achieved without departing from the spirit and scope of the invention. Therefore it is manifestly intended that the invention be limited only by the scope of the claims and the equivalence thereof.

What is claimed:

1. An anti-corrosive additive of the formula 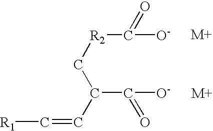
wherein M+ is selected from the group consisting of Na+ and K+; R₁ is a C₁ to C₂₄ branch or linear aliphatic compound and R₂ is a C to C₁₀ branch or linear aliphatic compound to be admixed with a composition prior to the intended use of said composition.

2. The anti-corrosive additive as defined in claim 1 wherein the composition is concrete for concomitant use with rebars in reinforced concrete structures.

3. The anti-corrosive additive in accordance with claim 2 wherein said anti-corrosive additive is present in an amount of from about 3 to about 5 pounds per cubic yard of concrete.

4. The anti-corrosive additive in accordance with claim 3 wherein said anti-corrosive additive is butane dioic acid dodecenyl disodium salt.

5. In a process of constructing a reinforced concrete structure, the improvement comprising the steps of
a. admixing an anti-corrosive compound of the formula 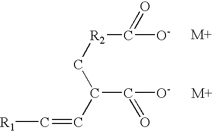
with concrete and using said resulting admixture in construction of said reinforced concrete structure.

6. The process of constructing a reinforced concrete structure as defined in claim 5 wherein said anti-corrosive additive is in an amount of from about 3 to about 5 pounds per cubic yard of cement.

7. The anti-corrosive additive in accordance with claim 6 wherein said anti-corrosive additive is butane dioic acid dodecenyl disodium salt.

8. A process for forming an anti-corrosive additive of the formula 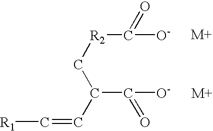
which comprises the steps of
(a) reacting an alkene of the formula C═C—R₁ with a cyclic dioic acid of the formula 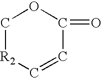
wherein R₁ is a C₁ to C₂₄ branch or linear aliphatic hydrocarbon and R₂ is a Cₒ-C₁₀ branch or linear aliphatic hydrocarbon to form 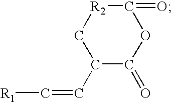
and
(b) reacting the product of step (a) with alkali hydroxide selected from the group consisting of sodium hydroxide and potassium hydroxide to form a soluble salt of the formula

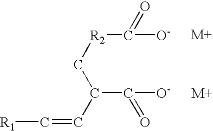

9. Applying to an iron based structure an effective amount of an anti-corrosive additive of the formula: 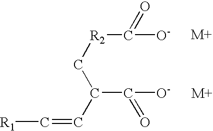
wherein M+ is selected from the group consisting of Na+ and K+; R₁ is a C₁ to C₂₄ branch or linear aliphatic compound and R₂ is a C to C₁₀ branch or linear aliphatic compound.

10. The process as defined in claim 9 wherein said anti-corrosive additive in a water based solution is applied to a surface of cured concrete.

11. The process as defined in claim 10 wherein said solution is applied directly into a crack in said concrete prior to repair.
